(19) United States
(12) Patent Application Publication
(10) Pub. No.: US 2007/0238799 A1
(43) Pub. Date: Oct. 11, 2007

(54) Odorless polyester polyol, odorless polyurethane foam and method for making the same

(75) Inventors: Tyler Housel, Lansdale, PA (US); Rocco Burgo, Mullica Hill, NJ (US)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Inolex Investment Corporation

(21) Appl. No.: 11/784,254

(22) Filed: Apr. 6, 2007

Related U.S. Application Data
(60) Provisional application No. 60/790,312, filed on Apr. 6, 2006.

(51) Int. Cl. C08G 18/00

(52) U.S. Cl. 521/172

(57) ABSTRACT

Odorless polyester polyols are described herein which are useful for forming substantially odorless polyurethane foams for cosmetic formulations. The polyester polyols are manufactured using a process that includes a stripping step to remove odorous volatile compounds.

### CROSS REFERENCE TO RELATED APPLICATIONS

This application claims the benefit under 35 U.S.C. §119(e) of U.S. Provisional Application No. 60/790,312, filed Apr. 6, 2006, the entire disclosures of which are incorporated herein by reference.

### BACKGROUND OF THE INVENTION

Polyurethane foam is formed from a reaction of a polyisocyanate and a polyol in the presence of water and possibly other blowing agents to provide a gas that fills the resulting cells. Approximately 80-99% of a typical polyurethane foam formulation consists of polyisocyanate, polyol and water. It is expected that these major components will react together to make a polyurethane polymer. This polymer is sufficiently stable and non-volatile so that it will generally have no odor under ambient conditions. Odors potentially come from non-reactive impurities that are present in the polyisocyanate, polyol, water or other ingredients. In particular, polyols generally have minute amounts of volatile impurities that impart a distinct odor.

Beyond the primary components, a polyurethane foam formulation requires silicone or organic surfactants to stabilize the foam and catalysts that control the rates of the various simultaneous reactions. Other additives may also be added to improve aesthetic or functional properties of the finished foam. These can include things such as perfumes, colorants, crosslinkers, plasticizers, fillers or flame retardants to impart specific properties. Many of these additives, and particularly volatile amine catalysts, can also contribute significantly to the odor of the foam. A summary of the typical ingredients for polyurethane foam is as described below.

The polyol is usually the largest component by weight in a polyurethane formulation, so any odorous impurities present in the polyol can impart an odor in the final foam. Polyols are normally polymers of a molecular weight of about 1,000-6,000 and that average between 2 and 4 reactive hydroxyl groups per molecule. Commercial polyols are generally based on repeating ester or ether units. These are commonly known as polyester polyols and polyether polyols. Polyols based on other repeat structures have been introduced but they have not achieved a wide market penetration in polyurethane foams.

The vast majority of polyester polyols used in the slabstock foam industry are made from diethylene glycol and adipic acid with additional functionality being imparted from small levels of glycerin, trimethylol propane or other monomeric polyols. Typical polyester polyols for slabstock foam have a hydroxyl value between 50 and 60 and hydroxyl functionality between 2.4 and 3.0. During the manufacturing process, the ingredients are processed at temperatures as high as 260° C. for as many as 48 hours. During this reaction, it is possible for impurities to form. Although the specific chemical components are not identified, certain polyester polyols, which are particularly useful for polyurethane foam formulation, have a distinct, sweet odor.

Polyether polyols are copolymerized from ethylene oxide and propylene oxide using a monomeric, diol or polyol as an initiator. These are available in a wider variety of crosslink densities and molecular weights than polyester polyols. Most polyether-based foams are used in cushioning applications such as seat cushions where odor is less of a factor.

All polyurethanes are made with reactive polyisocyanates. In the foam industry, the majority are aromatic polyisocyanates, broadly classified as toluene diisocyanate (TDI) types and methylene diphenyl diisocyanate (MDI) types. In slabstock foams, TDI is usually the isocyanate of choice. There are two isomers of TDI. The 2,6 isomer has two isocyanate groups ortho to the methyl group on a toluene ring. The 2,4 isomer has an isocyanate ortho and another para to the methyl group. Processes for manufacturing TDI always make a combination of the 2,4 and 2,6 isomers while little isocyanate is formed at the meta site. Therefore, other isomers (2,3 TDI, 3,4 TDI and 3,5 TDI) are present in insignificant quantities. Two types of TDI are typically manufactured for foam use. TDI-80 has 80% of the 2,4 isomer and TDI-65 has only 65% of the 2,4 isomer. In both cases, the remainder is the 2,6 isomer. Since all isomers and components of the polyisocyanate contain reactive isocyanate groups, it is expected that any potentially odorous components will react into the polymer matrix, rendering them non-volatile so they will not impart an odor on the final foam.

Water is added to essentially all polyurethane foam formulations. It reacts with isocyanate groups to produce carbon dioxide. This CO₂ is the gas that fills the cells and foams in the reacting mixture. Some grades of foam contain additional blowing agents that volatilize as the reaction exotherm heats the foam. These are typically low boiling liquids such as fluorocarbons, chlorofluorocarbons, hydrofluorocarbons, hydrochlorocarbons, acetone, cyclopentane, pentane and the like. Blowing agents are not reactive and highly volatile, so they can contribute significantly to foam odor. An odorless foam should be blown with an odorless blowing agent such as water or CO₂.

Once the liquid ingredients are mixed together, all reactions must proceed at the correct rates. In the foaming mixture, both polyol and water are vying to react with the available isocyanate groups. When the isocyanate reacts with water it produces the carbon dioxide gas that fills the cells. This is called the blowing reaction. When the isocyanate reacts with the hydroxyl groups from the polyol, it increases the average molecular weight, leading to higher viscosity, gelation and finally polymer strength. This is called the gel reaction. Since these reactions occur simultaneously, the rates must also be controlled relative to each other. For example, if the blowing reaction goes too fast, the gas will bubble out of the foam before it is elastic enough to expand. In this extreme case, the foam bun will collapse on itself. Catalysts are necessary to control each of these reactions. Normally tin or other metal catalysts primarily promote the gel reaction. Amine catalysts can promote either the gel or blowing reaction depending on the specific chemical structure. Amine catalysts are normally the most odorous components in a polyurethane foam. There have been many developments in low odor polyurethane catalysts over the years, and an odorless polyurethane foam will require catalysts designed specifically for minimal odor.

During the manufacturing process, liquid reactants are mixed together and bubbles form in the liquid. As the reaction proceeds, the bubbles grow and the molecular weight of the polymer increases, so that it eventually becomes a matrix of polymer surrounding cavities filled with gas. The final foam is stabilized by the crosslinked polymer structure, but while the reactants are still liquid, a surfactant is required to stabilize the bubbles and prevent them from coalescing. The surfactant also plays a critical role in forming the nucleation sites that will become the bubbles. All other additives to a foam formulation must be chosen such that they do not interfere with the nucleation and stabilization roles of the surfactant.

There are two types of surfactants commonly used to make polyurethane foams. These are broadly termed silicone types and organic types, depending on whether the chemical structure is based on polysiloxanes. Both types are usually blends of subcomponents that have various emulsification and cell stabilization functions. These emulsification and stabilization properties must work with the specific polyol, polyisocyanate and additives in the foam formulation. In practice, many different surfactant products are necessary because of the wide variety of foams produced. Historically surfactants have also been shown to produce specific odors in the foam. This has also been the subject of intense research, and it is expected that a modern, odorless surfactant will be required to produce odorless polyurethane foam.

Many types of foam are intended for specific uses that require special properties. To obtain different properties, additives are often used to modify an existing formulation. Examples of these additives would be flame retardants, colorants, crosslinkers, antimicrobials, fillers, light stabilizers, antioxidants and the like. These must be chosen in such a way that they do not compromise the goal of making an odorless polyurethane foam. In certain cosmetic foams, it is also possible to add fragrances to give the foam a pleasant scent. If so, the presence of a fragrance would not be in conflict with the goal of making an odorless foam.

Attempts to achieve odorless foams have been made. Huhtasaari et. al. presented a paper at the API Polyurethanes Expo in 2001 describing advances in low odor catalysts and surfactants for polyester polyurethane foams. The authors acknowledge that odor can be problematic in polyester polyurethane foams, although they focus on the contribution of the amine catalysts and silicone surfactants to remove most of the foam odor.

Duocastella-Codina et al. in U.S. Pat. No. 5,607,984 describe a process for stripping polyester polyols to remove non-reactive cyclic components that have been associated with an increase in windshield fogging in automobiles. In this process, they subject the polyester polyol to a continuous distillation at 250° C. under <1 torr vacuum with a residence time of 1 minute. This aggressive process is effective at removing the non-reactive cyclic components, and it is likely that it also removes other volatile compounds. However, this technique requires specialized equipment and uses the highly odorous catalyst N-ethyl morpholine, inconsistent with minimizing odor.

U.S. Pat. No. 6,924,321 of Casati et. al. is an example of work done to create a polyol with inherent catalytic characteristics. A main purpose of producing a catalytic polyol is to eliminate the need for volatile amines in the foam formula. These amines increase volatile emissions and contribute significantly to the typical odor found in polyurethane foam. It is believed that catalytic amines are significantly more odorous than typical polyester polyols. However, when using an odorless catalyst system, the odors from other ingredients, including polyester polyols are then more likely to become noticeable. The need for an odorless polyester polyol has been obscured by other foam odors until recent developments exemplified by U.S. Pat. No. 6,924,321.

Wendel et. al. in U.S. Pat. No. 6,858,654 describe catalyst combinations that have been developed to produce polyurethane foams with low odor characteristics. This work also focuses on reducing amine odors from polyurethane foam. While identifying the desire for a low odor foam product, this patent does not address odors caused by polyester polyol ingredients that would make the foam less desirable for cosmetic uses.

Ibbotson in U.S. Pat. No. 4,007,140 provide an early example of an amine polyurethane catalyst useful due to its low odor compared to catalysts generally available at the time.

U.S. Pat. No. 4,517,308 of Ehlenz et. al. describes an odor-absorbing medium having a sorbate, which is bound together by use of a polymerized polyurethane adhesive. This invention is an example of a polyurethane used in such a manner that odor is important to the development of an acceptable product. While they describe possible use in air fresheners and shoe inserts, cosmetic uses are not addressed.

### BRIEF SUMMARY OF THE INVENTION

The present invention includes an odorless polyester polyol useful for producing an odorless polyurethane foam for use in, for example, cosmetic formulations.

A process for manufacturing a polyester polyol is also included in the invention and comprises stripping the polyester polyol to remove volatile compounds, wherein the resulting stripped polyester polyol is substantially free of odor and useful for producing low-odor polyurethane foam.

Also within the invention is a method for producing a substantially odorless polyurethane foam from an odorless polyester polyol. A method for manufacturing a substantially odorless cosmetic grade of polyurethane foam comprises using a polyester polyol that is made by a process comprising a stripping step for removing odorous volatile components.

Further, the invention includes a substantially odorless polyurethane foam useful in cosmetic formulations. Such a cosmetic grade of polyurethane foam is manufactured by a formulation comprising a substantially odorless polyester polyol, wherein the substantially odorless polyester polyol is manufactured by a process comprising a stripping step to remove odorous volatile compounds.

### DETAILED DESCRIPTION OF THE INVENTION

The invention described herein provides a technology that is able to provide odorless polyester polyols that can then be used for making odorless polyurethane foams for, among other things, cosmetic uses. It further provides a method for converting an odorless polyester polyol into a substantially odorless polyurethane foam, which substantially odorless foam is useful in cosmetic formulations as noted herein. As used herein, “substantially odorless” means that the polyol or resulting polyurethane exhibit little discernible odor and that to the extent odor is present it is difficult to detect and mild and would otherwise not interfere with a chosen fragrance for a resulting cosmetic or other product incorporating the polyol or polyurethane foam or would not be overtly detectible to a user of a “fragrance free” cosmetic or other product, and “substantially odorless” also encompasses virtually completely odor free and completely odor free within its scope.

The main component in a substantially odorless foam is an odorless polyester polyol. The polyester polyol is initially manufactured by production methods that would produce a standard foam grade polyester polyol. These products typically have a number average molecular weight of between about 1000 and about 4000, an equivalent weight between about 500 and about 2000, a hydroxyl value between about 28 and about 110 and a hydroxyl functionality between about 2.0 and about 3.5.

Such a polyester polyol is generally manufactured from adipic acid and one or more linear glycols such as diethylene glycol, ethylene glycol, 1,3 propanediol, 1,4 butanediol and 1,6 hexanediol. In addition, small amounts of higher functionality alcohols such as glycerin or trimethylolpropane can be included to increase the hydroxyl functionality. Examples of these typical polyester polyols are Lexorez® 1102-50AT, Lexorez® 1102-50FT, and Lexorez® 1102-60FT, each of which is manufactured by and available from the Inolex Chemical Company of Philadelphia, Pa.

The polyester polyols as noted above are made odorless in accordance with the invention by an additional post-treatment that removes volatile odorous impurities.

The odorless foams of the present invention are made from aromatic isocyanates such as toluene diisocyanate (TDI) as a reactive ingredient, and use water as the primary blowing agent. The amount of isocyanate should be approximately stoichiometric such that the total number of isocyanate groups per unit mass should be within about 15% of the total amount of reactive hydroxyl, water and amine groups in the same mass.

The substantially odorless foam formulation preferably includes a catalyst to control the rate of reaction. Preferred catalysts for use in the invention include tertiary amines or ureas that have been selected so as to impart substantially no odor in the final foamed article. This can be accomplished by any technique that may render the amine non-volatile. Specific examples include DABCO® NE400, DABCO® NE500, DABCO® NE600 and DABCO® T, all available from Air Products and Chemicals in Allentown, Pa., and Jeffcat® ZF-10, Jeffcat® DMEA, Jeffcat® ZR-70, Jeffcat® ZR-50, Jeffcat® DPA, and Jeffcat® DPA-50, each available from Huntsman Corporation, Houston, Tex. Catalysts are present generally in an amount of about 0.1 to about 3.0 weight percent of the composition based on 100 parts by weight of polyester polyol.

A substantially odorless polyurethane foam further preferably includes one or more interfacially active agents to emulsify the ingredients and stabilize the cellular structure before the polymer builds sufficient molecular weight to support itself. The preferred surfactant combination may contain separate ingredients for stabilization and emulsification, but all ingredients are most preferably compatible with the goal of making an odorless foam product. It has been found by the inventors herein that many commercial polyurethane foam surfactants impart excessive odor to the foam. Commercial examples of substantially odorless foam stabilizers are DABCO® DC4000 and DABCO® DC4020 available from Air Products and Chemicals and Silbykg 9110 from Byk Chemie. Surfactants are preferably present in the formulation in amount of from about 0.1 to about 3.0 weight percent based upon 100 parts of polyester polyol.

Optionally, fragrances, perfumes or dyes may be added to the foam formula to impart a desirable scent and/or coloration to the final foam product. These will likely affect the smell of the foam, and should not be considered an odor for the purpose of this invention. Other optional ingredients can be included in the odorless foam to impart specific performance properties. These include flame-retardants, fungicides, bactericides, anti-microbials, plasticizers, crosslinking polyols, UV-absorbers, thickeners, thixotropic agents, preservatives, diamines, antioxidants and so on. If additives such as these are present, they should be chosen such that they do not compromise the goal of producing a substantially odorless foam for cosmetic use. Beyond that requirement, optional ingredients that are known or to be developed may be used within the scope of the invention, but are not required. Additives can be provided in varying amounts. Preferably, the additives collectively make up no more than about 30 weight percent of the formulation based on 100 parts by weight of polyester polyol.

The polyester polyols according to the invention are made using a process in which the polyester polyols, preferably polyester polyols such as those described above, are stripped to be substantially free of odor so as to be useful for producing low odor polyurethane foams.

The polyester polyols are formed from compositions that include components such as those described above including at least one diacid and at least one monomeric diol and/or dimeric diol. As used herein “a” means one or more and is equivalent to “at least one” unless otherwise specified. Optionally included in the compositions are monomeric triols. The compositions can include diacids, diols and triols which are the same or different than a primary diacid, diol and/or triol. Preferably, the diacid is adipic acid, although it is within the scope of the disclosure to include various types of diacids commonly used and/or to be developed in the art for polyester polyol formation.

The monomeric and/or dimeric diols are preferably chosen to be alkyl or alkylene diols or glycols, such as, for example, but without limitation preferred compounds including ethylene glycol, propandiol, butanediol and diethylene glycol and combinations thereof.

Optional, useful monomeric triols, which can be incorporated in the compositions, include glycerin, trimethylol propane and trimethylolethane and combinations thereof. However, other triols or other high alcohols can also be used.

The polyester polyols are stripped by heating to above about 100° C. and injecting steam into the polyester polyol. The polyol is then preferably maintained at a temperature of about 100° C. to about 150° C. upon injection of the steam.

The treatment preferably occurs in a stripping vessel in which steam may be injected which has heating capability through whatever acceptable source. The vessel and its contents, including the polyester polyol are preferably kept at a pressure which is less than ambient, more preferably at less than about 100 torr and most preferably less than about 20 torr.

Steam is preferably continuously injected into the vessel at a rate of about 0.002 to about 0.04 pounds/hour/pound of polyester, more preferably 0.006 to about 0.015 pounds/hour/pound polyester. The stripping step preferably lasts about 0.1 to about 25 hours, and more preferably about 1 to about 10 hours.

It is exceedingly difficult to develop a useful machine method to quantify odor properties. Therefore, trained volunteers were used to measure the odor by qualitatively ranking the various specimens. The odor testing was done in a blind study with appropriate controls introduced to ensure consistency. Polyester polyol odor testing was done with Inolex Chemical Company test method QCM116. In this test, approximately 4 ounces of the polyester is added to an 8 ounce glass jars. The judges then rate the odor of the contents immediately after opening the jar on a scale of 0 (odorless) to 10 (suffocating).

### EXAMPLE 1

The following example illustrates preferred embodiments of odorless polyester polyols that can be used to manufacture odorless polyurethane foams suitable for cosmetic uses. Further examples demonstrate the method for producing essentially odorless polyurethane foams from these odorless polyester polyols, as well as the olfactory properties of the essentially odorless foams for cosmetic uses.

Manufacture of Base Polyester Polyols (Polyol A and Polyol B):

A three-component polyester polyol (Polyol A) was made from 375 pounds of adipic acid, 294 pounds of diethylene glycol and 13 pounds of glycerin. A catalytic amount (37 grams) of tetrabutyl titanate was also added during the process.

These components were reacted at 200-230° C. for 22 hours. To produce a polyester polyol that had a typical sweet odor with a hydroxyl value of 54, equivalent weight of 1040 and viscosity of 22,000 centipoise at 25° C.

A three-component polyester polyol (Polyol B) was made from 375 pounds of adipic acid, 294 pounds of diethylene glycol and 13 pounds of glycerin. A catalytic amount (37 grams) of tetrabutyl titanate was also added. These components were reacted at 200-230° C. for 22 hours. The final polyester had a typical sweet odor with a hydroxyl value of 54, equivalent weight of 1040 and a viscosity of 22,500 cps at 25° C. Polyol A and Polyol B were made under duplicate conditions, and the final properties are quite similar.

A factory made sample of Lexorez® 1102-50FT was taken from the regular manufacturing process to serve as a control (Polyol C).

Process for Removing Odor Components of Polyol A and Polyol B:

Polyol A was treated to remove volatile, odorous impurities. In this process, 575 pounds of Polyol A was held between 110-130° C. while steam was injected into the material at a constant rate of 5 pounds per hour at 100 psig. During the 8 hour stripping process, the reactor was held at a vacuum of 10-20 torr. The resultant odorless polyol (Stripped Polyol D) had a final acid value of 1.17, hydroxyl value of 51.5, equivalent weight of 1090, viscosity of 23,4000 cps at 25° C. and a moisture of 0.010%.

Polyol B was treated to remove volatile, odorous impurities. In this process, 575 pounds of Polyol B was held between 110-130° C. while steam was injected into the material at a constant rate of 5 pounds per hour at 100 psig. During the 8 hour stripping process, the reactor was held at a vacuum of 10-20 torr. The resultant odorless polyol (Stripped Polyol E) had a final acid value of 1.18, hydroxyl value of 49.5, equivalent weight of 1130, viscosity of 24,000 cps at 25° C. and a moisture of 0.025%.

A trained panel of six (6) judges performed the odor testing on the polyester polyols using Inolex Chemical Company odor method QCM116. The judges were not advised of the identification of the sample until all testing was complete. The results appear below in Table 1.

TABLE 1

| Polyester polyol | Odor Ranking | Odor Description |
|---|---|---|
| Polyol A | 2.6 | Low odor |
| Polyol B | 1.8 | Low odor |
| Polyol C | 2.7 | Low odor |
| Stripped polyol D | 0.4 | Odorless |
| Stripped polyol E | 0.7 | Odorless |

### EXAMPLE 2

A Table of Foam Ingredients appears below in Table 2

TABLE 2

| Ingredient | Code | Function | Supplier |
|---|---|---|---|
| Polyester polyols A and C | | Reactant | Inolex Chemical |
| Stripped polyester polyols D | | Reactant | Inolex Chemical |
| and E | | | |
| Water | | Reactant | Inolex Chemical |
| Tolylene 2,4 diisocyanate tech | TDI-80 | Reactant | Aldrich Chemical |
| 80% | | | |
| Dabco T (N-methyl-N-(N,N- | Dab T | Catalyst | Air Products and |
| dimethylaminoethyl)- | | | Chemicals |
| aminoethanol | | | |
| Jeffcat ZF-10: (N,N,N′- | ZF-10 | Catalyst | Huntsman |
| trimethyl-N′-hydroxyethyl- | | | |
| bisaminoethylether) | | | |
| Silbyk 9110 organic | Sil9110 | Surfactant | Byk Chemie |
| surfactant blend | | | |

A series of polyurethane foams were prepared from combinations of the above ingredients in Table 2 that were chosen with the goal of producing a substantially odorless polyurethane foam for cosmetic use. The foams listed below in Table 3 were made by combining the ingredients in the stated ratios. TDI and polyol were premixed at slow speed for approximately 20 seconds. Immediately thereafter, the catalyst, water and surfactant were added. Then the components were mixed at approximately 2500 rpm for 6-7 seconds and poured into a rectangular box. The foam was allowed to react at room temperature, and within 3 minutes, all had reached full rise height. This technique is typical for bench scale simulation of the commercial foaming process. It is understood that the mechanical process of combining and mixing the ingredients is not part of the invention and only serves to produce specimens for further testing. Table 3 below illustrates Formulation Examples of Odorless Polyurethane Foams according to the invention.

TABLE 3

| Foam | | Parts by weight | | | | | |
|---|---|---|---|---|---|---|---|
| ID | Polyol | Polyol | Water | TDI-80 | ZF 10 | Dab T | Sil9110 |
| C-1 | A | 100 | 2.5 | 33 | 0.3 | — | 0.5 |
| C-2 | C | 100 | 2.5 | 33 | 0.3 | — | 0.5 |
| C-3 | A | 100 | 2.5 | 33 | — | 0.3 | 0.5 |
| C-4 | C | 100 | 2.5 | 33 | — | 0.3 | 0.5 |
| S-7 | D | 100 | 2.5 | 33 | 0.3 | — | 0.5 |
| S-8 | E | 100 | 2.5 | 33 | 0.3 | — | 0.5 |
| S-9 | D | 100 | 2.5 | 33 | — | 0.3 | 0.5 |
| S-10 | E | 100 | 2.5 | 33 | — | 0.3 | 0.5 |

As before, a trained panel of judges blindly assessed the odor of the foam samples. In each trial, a judge was given three foam samples, each contained in a sealed glass jar. In each set of samples, there was either one or two foams made with a stripped polyol and the rest were made with control (unstripped) polyols. The judge was asked to identify the one that was different and whether it was best or worst in the group. To avoid prejudicing the judge, they were not told how many foams with stripped polyol were in each trial set.

A total of 28 trials were conducted with 8 different judges. There were 14 “best” votes, 12 “worst” votes and 2 where the judge could determine no difference between the foams. Tallying the results, 10 of the 14 “best” votes and 0 of the 12 “worst” votes went to foams made with stripped polyol. This means that only 4 of the 26 sets were misidentified. Given the subjective nature of the test, these results are quite conclusive that the foams made with stripped polyol gave off significantly less odor.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A process for manufacturing a polyester polyol, comprising
stripping the polyester polyol to remove volatile compounds, wherein the resulting stripped polyester polyol is substantially free of odor and useful for producing low-odor polyurethane foam.

2. The process for manufacturing a polyester polyol according to claim 1, wherein the stripped polyester polyol is formed from a composition comprising
a diacid
a monomeric and/or a dimeric diol
and a monomeric triol

3. The process for manufacturing a polyester polyol according to claim 2, wherein the composition further comprises a second diacid different than the diacid, a second diol different from the diol and/or a second triol different than the triol.

4. The process for manufacturing a polyester polyol according to claim 2, wherein the diacid is adipic acid.

5. The process for manufacturing a polyester polyol according to claim 2, wherein the monomeric and/or dimeric diol is selected from the group consisting of ethylene glycol, propanediol, butanediol, and diethylene glycol.

6. The process for manufacturing a polyester polyol according to claim 2, wherein the monomeric triol is selected from the group consisting of glycerin, trimethylolpropane and trimethylolethane.

7. The process for manufacturing a polyester polyol according to claim 1, further comprising heating the polyester polyol above about 100° C. and injecting steam into the polyester polyol.

8. The process for manufacturing a polyester polyol according to claim 1, further comprising maintaining the polyester polyol at a temperature between about 100° C. and about 150° C. and injecting steam into the polyester polyol.

9. The process for manufacturing a polyester polyol according to claim 1, further comprising maintaining contents of a stripping vessel, including the polyester polyol, at a pressure which is less than ambient.

10. The process for manufacturing a polyester polyol according to claim 1, further comprising maintaining contents of a stripping vessel, including the polyester polyol, at a pressure of less than 100 torr.

11. The process for manufacturing a polyester polyol according to claim 10, wherein the contents of the stripping vessel are maintained at a pressure of less than 20 torr.

12. The process for manufacturing a polyester polyol according to claim 1, further comprising injecting steam continuously into a stripping vessel comprising the polyester polyol.

13. The process for manufacturing a polyester polyol according to claim 12, wherein the steam is continuously injected into the stripping vessel at a rate of about 0.002 to about 0.04 pounds per hour per pound of polyester.

14. The process for manufacturing a polyester polyol according to claim 13, wherein the steam is continuously injected into the stripping vessel at a rate of about 0.006 to about 0.015 pounds per hour per pound of polyester.

15. The process for manufacturing a polyester polyol according to claim 1, wherein the stripping step lasts about 0.1 to about 25 hours.

16. The process for manufacturing a polyester polyol according to claim 15, wherein the stripping step lasts about 1 to about 10 hours.

17. A method for manufacturing a substantially odorless cosmetic grade of polyurethane foam, comprising using a polyester polyol which is made by a process comprising a stripping step for removing odorous volatile components.

18. The method for manufacturing a substantially odorless cosmetic grade of polyurethane foam according to claim 17, further comprising selecting additional components in a foam formulation comprising the polyester polyol as to impart no additional odor to the polyurethane foam.

19. A cosmetic grade of polyurethane foam manufactured by a formulation comprising a substantially odorless polyester polyol, wherein the substantially odorless polyester polyol is manufactured by a process comprising a stripping step to remove odorous volatile compounds.

20. A cosmetic grade of polyurethane foam according to claim 19, further comprising selecting additional components in a foam formulation comprising the polyester polyol so as to impart no additional odor to the polyurethane foam.
